(19) United States
(12) Patent Application Publication
(10) Pub. No.: US 2025/0251950 A1
(43) Pub. Date: Aug. 7, 2025

(54) AI-DRIVEN ANALYTICS AND AUTOMATED RETENTION ASSESSMENTS

(71) Applicant: Re Recruit, Inc., Vernon Hills, IL (US)

(72) Inventors: Jeffrey Schrimmer, Vernon Hills, IL (US); Fortune Emmanuel-King, Vernon Hills, IL (US)

(21) Appl. No.: 19/044,538

(22) Filed: Feb. 3, 2025

Related U.S. Application Data
(60) Provisional application No. 63/548,753, filed on Feb. 1, 2024.

(51) Int. Cl. G06F 9/451; H04L 67/306

(52) U.S. Cl. CPC G06F 9/451; H04L 67/306

(57) ABSTRACT

Systems and methods for performing intelligent retention assessments, recommendations, and custom graphic interfaces are provided. Information may be stored in memory regarding one or more retention categories of users. Each category may be associated with a corresponding set of online activity indicators. A plurality of online platforms accessible a communication network may be monitored for one or more online data changes in accordance with a profile. Data may be aggregated from the online platforms regarding detected changes in online data associated with the profile. One of the retention categories may be assigned to the profile by applying an artificial intelligence model to the aggregated data. The artificial intelligence model may have been trained to correlate online data with the set of indicators corresponding to the retention categories. A custom graphic user interface may be generated based on a threshold associated with the assigned retention category, which may be displayed at a user device and includes a notification that the threshold associated with the assigned retention category has been met.

### CROSS-REFERENCE TO RELATED APPLICATIONS

The present patent application claims the priority benefit of U.S. provisional patent application No. 63/548,753 filed Feb. 1, 2024, the disclosure of which is incorporated by reference herein.

### BACKGROUND OF THE INVENTION

### 1. Field of the Invention

The present system generally relates to analytics and automated assessments of online activity patterns. More specifically, the present system relates to providing AI-driven analytics of user online activity data and automated retention assessments.

### 2. Description of the Related Art

Presently available systems for managing employees generally involve surveying the current employees or conducting exit interviews for departing employees after they have given notice of intent to leave current employment. Such surveys and interviews, however, are not only time-intensive upon current and now possibly short-handed personnel, but may also fail to elicit accurate or complete data regarding employee morale, reasons for leaving, and how the employer may improve employee retention. Individual interviews may also fail to reveal systemic problems within an organization, such as location-specific conditions, poor management of specific teams or divisions, etc. Further, exit interviews are also generally not geared towards retaining the particular employee that is departing employment, and it may be too late at that point to implement retention measures effectively. Surveys and interviews are also prone to bias by those formulating the questions or conducting the interview, as well as fail to detect the likelihood of an employee leaving at an early enough stage so as to permit opportunities for interventions, course correction, and/or other retention strategies. Such initiatives relying on surveys and interviews are also not scalable for employers with large numbers of employees at different locations performing different jobs with different roles and responsibilities under different conditions.

Such surveys or exit interviews may also be highly specific to the individual being surveyed or interviewed, thereby failing to provide any actionable insights that could be used to assess other individuals that an employer may wish to retain, let alone used to formulate, customize, or scale strategies across an entire workforce. Even if such surveys or exit interviews were conducted electronically or automatically, therefore, their results may not be useful. Moreover, presently available online activity data tracking systems lack the ability to filter data from multiple different online platforms regarding any number of known or unknown (e.g., anonymized) users nor present a subset of data in a useful manner.

Therefore, there is a need in the art for improved systems and methods for assessing online activity data regarding individual employees in real-time and making recommendations for employee retention.

### SUMMARY OF THE CLAIMED INVENTION

Embodiments of the present invention include systems and methods for performing intelligent retention assessments. Information may be stored in memory regarding one or more retention categories of users. Each category may be associated with a corresponding set of online activity indicators. A plurality of online platforms accessible a communication network may be monitored for one or more online data changes in accordance with a profile. Data may be aggregated from the online platforms regarding detected changes in online data associated with the profile. One of the retention categories may be assigned to the profile by applying an artificial intelligence model to the aggregated data. The artificial intelligence model may have been trained to correlate online data with the set of indicators corresponding to the retention categories. A custom graphic user interface may be generated based on a threshold associated with the assigned retention category, which may be displayed at a user device and includes a notification that the threshold associated with the assigned retention category has been met.

### BRIEF DESCRIPTION OF THE DRAWINGS

FIG. 1 illustrates an exemplary network environment in which a system for intelligent retention assessment may be implemented.

FIG. 2 is a flowchart illustrating an exemplar method for intelligent retention assessment.

FIG. 3 illustrates exemplary data flows and content generated during implementation of intelligent retention assessment.

FIGS. 4A-C illustrates exemplary graphic user interface displays that may be generated during implementation of intelligent retention assessment.

FIG. 5 is a block diagram of an exemplary computing device that may be used to implement an embodiment of the present invention.

### DETAILED DESCRIPTION

Embodiments of the present invention include systems and methods for performing intelligent retention assessments. Artificial intelligence (AI) is utilized to monitor changes in employee profiles on various online platforms and assign a retention category to the profiles based on the monitored changes. A notification and a custom graphic user interface (GUI) may be generated based on the assigned retention category. Such notification and custom GUI may provide an insight and a recommendation to employers to improve employee retention.

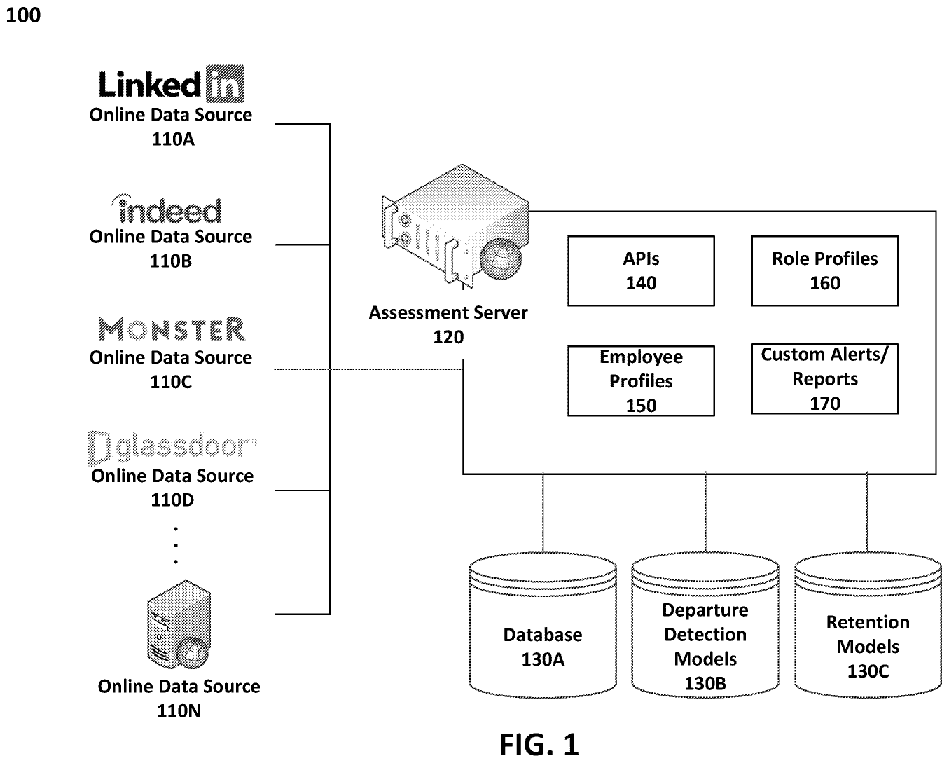

FIG. 1 illustrates an exemplary network environment 100 in which a system for intelligent retention assessment may be implemented. As illustrated, network environment 100 may include different online data sources 110A-N, assessment server 120, and databases 130A-C. The assessment server 120 may also include APIs 140, employee profiles 150, role profiles 160, and custom alerts/reports 170.

Online data sources 110A-N may include any variety of online professional social networks, job search websites, resume sharing networks, or other online source of data regarding employee professional activities, including industry-specific networks or websites. Such online data sources 110A-N may be monitored in accordance with parameters associated with a particular employer entity and their respective employees in different job roles and performing specific responsibilities. Such parameters may include not only employee-specific data (e.g., employee profiles 150), but also job or role data (e.g., role profiles 160). Online data sources 110A-N may thus provide updates to assessment server 120 when employee data is updated or when data appearing to be associated with an employee is updated. Such updates may be detected in real-time or gathered at periodic intervals.

Assessment server 120 may include any data server known in the art that is capable of communicating with the different online data sources 110. Assessment server 120 may be implemented on one or more cloud servers that carry out instructions associated with analyzing employee and employment data. The assessment server 120 may further carry out instructions, for example, for monitoring and capturing data regarding one or more employees or employee roles, as well as generate alerts and reports in response to one or more triggers. In addition, the assessment server 120 may also identify systemic patterns and generate recommendations for correcting or otherwise improving the identified systemic conditions (e.g., as reflected by retention statistics and trends over time).

While pictured separately, the databases 130A-C may be any type of memory or storage device known in the art. Databases 130A-C may be stored on any of the servers and devices illustrated in network environment 100 on the same server, on different servers, or in association with any user devices in communication with assessment server 120. One or more databases 130A may store data specific or proprietary to a company, including employee records (including resumes), job titles, job descriptions (e.g., from job postings or resumes of individuals that have or are performing the job), organizational or management structures (e.g., offices, teams, divisions, managers, or other groupings and relationships therebetween), industry-specific data, etc.

In addition, databases 130B-C may store and maintain learning models and associated data. Machine learning techniques (e.g., similar to deep learning used by large language models trained using large data corpora to learn patterns and make predictions with complex data) and neural networks may further be applied to train a model based on employee data, including employer and associated employment data, which may be reflected in resumes, job descriptions, employment records, job changes, and the like. Such models may be trained to recognize patterns between certain employee attributes and likelihood of departing employment, as well as to predict when a particular user becomes more likely to leave employment and the cause of the increased likelihood. In some implementations, training sets of employee data records may be labeled in accordance with any combination of employment status, data associated with changes in employment status (e.g., occurring within certain timeframes), retention strategies deployed, and success or failure thereof.

One database may include departure detection models 130B trained to detect likelihood of departure by individual employees. The departure detection models 130B may analyze training data regarding profiles and online activities (as provided by online data sources 110A-N) associated with departed employees to identify indicators and patterns thereof correlating to likelihood that an employee will depart employment. Once trained, such departure detection models 130B may thereafter be applied to current employee data and associated online activities to predict when the current employee shows indicators of dissatisfaction or desire to depart employment. In some implementations, departure detection models 130B may be customized to employee categories specific to a particular entity, e.g., whereby different types of employees may be determined to exhibit different patterns of online activities when dissatisfied or preparing to depart employment. Departure detection models 130B may also detect systemic issues where groups of similarly situated employees are identified as likely to depart employment due to the same or similar causes or factors (e.g., common manager, workload, etc.).

Retention models 130C may be trained to identify retention measures for addressing individual and systemic retention problems. Different retention strategies for improving employee engagement, compensation packages, work assignments and allocations, and other changes to employment conditions may be correlated to success or failure to retain employees. Such data may be tracked over time and used to train retention models 130C on which strategies may be most effective for individual employees, as well as address identified systemic problems.

As online data sources 110A-N and internal databases 130A are monitored, such data may reflect emerging patterns regarding employers, employees, or employment relationships. Such data may also be added to one or more profiles for use in modeling employee satisfaction or likelihood of departure. As such, the employee profile may be continually updated with new data, new emerging patterns, and new predictions, which may be used to refine pattern recognition and predictions by learning models 130B-C associated with the employer or employee, including learning models trained to detect early stages of employee dissatisfaction and increasing likelihood of departure from current employment situations, as well as make recommendations as to retention strategies for retaining the employee. In addition to the individualized assessment and recommendations, learning models may also be trained to detect larger or systemic patterns across a team, office, division, or other grouping within an organization and to make recommendations for systemic improvement.

User feedback—including updated employment records—may also be elicited and used to refine learning model predictions as to likelihood of departure, associated causes or factors, recommended retention measures, and success or failure thereof. Such user feedback may be used not only to tailor subsequent retention or change recommendation for the specific employee or similarly situated employees, but also for employers or employment situations identified as sharing similar attributes or conditions. Thus, the assessment server 120 may affirm such associations or patterns by querying administrators for feedback that may thereafter be used to further update and refine the models, as well as monitoring current employment and retention data.

The machine learning models 130B-C may thus be trained to process natural language communications (e.g., such as verbal, textual, etc.) in conjunction with available employee data to identify attributes, online activities, and changes thereto as indicators associated with one or more predetermined categories of job satisfaction/dissatisfaction and likelihood of maintaining current employment or departure. Different machine learning models may be trained using different types of training data, which may be specific to the employee, employee grouping or demographic, associated employment conditions etc. Using the selected training data sets, therefore, the machine learning model may be trained to identify when a specific employee exhibits indicators that are associated with a different category of job satisfaction/dissatisfaction and likelihood of job departure.

In addition, such databases 130A-C may also be used to store or link to various stores for APIs 140, employee profiles 150, role profiles 160, custom alerts/reports 170, etc., used for intelligent retention assessment. A particular employee may be associated with different types of indicators as reflected by online data or changes thereto, which may also be provided in alerts or reports for context with respect to evaluating the activities expressly or implicitly associated with the employee. Such data may also be used to train, customize, and refine learning models 130B-C to recognize new type of behaviors that are indicative of employee dissatisfaction and intent to depart from employment.

Online data from online data sources 110A-N may be provided to assessment server 120 using one or more APIs in API store 140, which allows various types of network systems in network environment 100 to communicate with each other. The APIs in API store 140 may be specific to the particular operating language, system, platform, protocols, etc., of the online data sources 110A-N, as well as the assessment server 120, databases 130A-C, and other devices or systems of network environment 100. In a network environment 100 that includes multiple different types of systems and devices, there may likewise be a corresponding number of APIs that allow for various formatting, conversion, and other cross-device and cross-platform communication processes for providing data and other services to different systems and devices, which may each respectively use different operating systems, protocols, etc., to process such data. As such, applications and services in different formats may be made available so as to be compatible with a variety of different systems and devices.

Employee profiles 150 may include any type of data regarding an employee, including employee records, resumes, job history, job title, roles and responsibilities, current job performance data, etc., which may be maintained by an employer. Similarly, role profiles 160 may include any type of data regarding an employment role within an organization, including employee data of employees that have or are performing in such an employment role. In addition, online data and user feedback (e.g., from system administrators) may be matched to or otherwise associated with a particular employee and thus used to update the relevant employee profile. For example, an anonymized resume posted online may be matched to a particular employee based on similarities to an employee profile. Data regarding such online activities as posting resumes online may thus be highly correlated to a job dissatisfaction and intent to depart employment.

Custom alerts/reports 170 may include selected triggers, formats, and other preferences specific to an organization or employer. Custom alerts/reports 170 may, for example, specify different thresholds for triggering alerts by employee role within an organization. For example, a “medium” likelihood of departing employment may not trigger an alert for one employee or group of employees, but may trigger an alert for a different employee or group of employees. In addition, different reports (e.g., dashboards, charts, graphic user interface displays) may be automatically generated upon request, in real-time, or periodically based on preselected preferences.

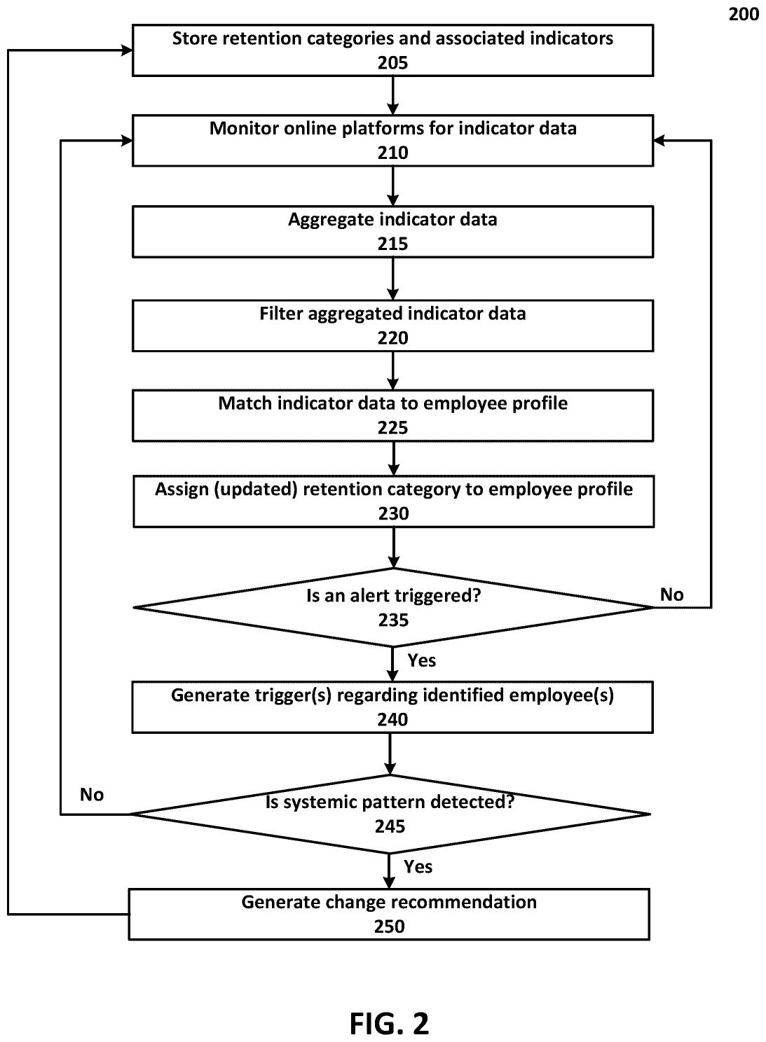

FIG. 2 is a flowchart illustrating an exemplar method 200 for intelligent retention assessment. The method 200 of FIG. 2 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 2 (and the order thereof) are exemplary and may include various alternatives, equivalents, or derivations thereof including but not limited to the order of execution of the same.

In step 205, information may be stored in memory regarding retention categories and associated indicators. The retention categories may correspond to different levels of likelihood of that an employee will depart employment. For example, retention categories may be “outlier,” “high,” “medium,” and “low,” in which the “outlier” represents very high likelihood of the employee leaving and “low” represents little or no likelihood that the employee is leaving. The likelihood of an employee leaving may be indicated by a set of indicators, such as changes to the profile of the employee on professional networking website. The detected changes may also be used to identify a rate of change, e.g., the frequency at which the employee is entering updates to the resume or the profile in a given period of time, or the quality of changes, e.g., the type of changes or the amount of new information.

Each retention category may be associated with a different set of indicators. For example, updating minor details on an employee profile may be associated with “low” retention category, updating details of the previous place of employment may be associated with “medium” retention category, adding a new skill may be associated with “high” retention category, and updating the accomplishments of the current place of employment may be associated with “outlier” retention category. In an embodiment, a score may be assigned based on the rate or quality of changes and the score may be associated with a certain category. For example, updating an address on an employee profile may be given a lower quality of change score than updating to add a key metrics.

In another embodiment, the retention categories may reflect the changes to the employee profile that deviates the norm. For example, the employee profile that is updated frequently may still be associated with “low” category if the changes to the employee profile is routine, based on the observation of the employee profile over time. In this example, only when the updates to the employee profile are more frequent or more significant than the norm, would the retention category escalate to “medium,” “high,” or “outlier.”

AI models may be trained with data from profiles of former employees and the changes to the former employee profiles on the online platforms over time until their departure. For example, the extent, the frequency, and the quality of changes to the former employee profile just prior to the departure of the former employee may serve as initial points for the set of indicators for “outlier” retention category. The changes to the former employee profile at some time period before the departure may serve as initial points for the set of indicators for “high” retention category.

In step 210, a plurality of online platforms is monitored over a communication network for changes associated with profiles. The online platforms may be social media websites, such as LinkedIn, networking websites such as, Dice.com, or resume websites such as Indeed. The system may utilize artificial intelligence (AI) to continuously collect data regarding the existence and the changes to the profiles associated with employees on the online platforms. The online data collected may include a name of the employee, a current or latest listed place of employment, length of employment, job title, location of the employment or the employee, etc. The collected online data may be anonymized to protect privacy of the employee or to meet governmental regulations. However, the AI may still match a profile without a name with a particular employee, based on other data associated with the profile, such as the name of the employer, the location of the employment, and the job title.

In step 215, the collected data may be aggregated from the online platforms. The collected data regarding the profiles may be aggregated based on employment location (city, region, state, country), job title, managers of the employees associated with the profiles, division or department within the place of employment, and management level. In one embodiment, one employee may have more than one profiles on the online platforms. The system may identify each of the profiles as being associated with an employee and aggregate the data collected from the profiles.

In step 220, the aggregated indicator data may be filtered based on relevance to current employees, current employment roles, and current employment concerns. A particular employer or organization may wish merely to track certain employees or groups or types thereof. As such, much of the aggregated data may be determined to be irrelevant and filtered out of the data set prepared for analysis by one or more learning models. In some instances, data regarding similar or similarly-situated users (even if anonymized) may be included in the filter results as potentially be associated with a particular user and thus useful in as bases in generating predictions and analyses relevant to the user.

In step 225, indicator data within the data set may be matched to specific employees or categories by group or type employee. Such matches or categorization may be used to update employee or role profiles, as well as analyzed by learning models to detect different levels of intent to depart employment in step 230

In step 230, retention categories may be assigned to the profiles by applying one or more selected artificial intelligence models to the data set. Natural language processing may be used to determine the extent and the type of changes to the profiles on the online platforms. In some implementations, weights or scores may be assigned to indicators within the profiles based on the extent and type of changes. The retention categories may be assigned to profiles based on the scores. AI model that is trained with data from profiles of former employees and the changes to the former employee profiles on the online platforms over time may serve as initial training sets for assignment of retention categories. The trained models may thereafter be able to correlate the indicators in the data set (including data from the online data sources 110A-N) with the corresponding retention categories. The assigned retention category may be the same or exhibit changes over time.

In some implementations, retention categories may be assigned based on the changes to the employee profile that deviates the norm. For example, the employee profile that is updated frequently may still be associated with “low” category if the changes to the employee profile is routine, based on the observation of the employee profile over time. In this example, only when the updates to the employee profile are more frequent or more significant than the norm, would the retention category escalate to “medium,” “high,” or “outlier.”

The likelihood of an employee leaving or the set of indicators may be translated into a score to assign employee profiles into a certain retention category if the score exceeds a threshold value associated with each retention category. In an embodiment, each retention category may be assigned different threshold value. For example, if an employee profile is edited to modify a key performance indicator or other important metrics, the change to the profile would be assigned a quality of change score above the threshold value for “high” retention category. In another example, modifying the address on a resume in the employee profile would be assigned a quality of change score less than the threshold value for “high” retention category. Such assigned threshold values may be set by an administrator. The threshold value may be set based on the needs of the employer. Depending on the needs of the employer, the threshold value to associate an employee with “outlier” retention category may be high or low.

In some instances, the threshold value for each category may be different for each employee. For example, an employee that regularly changes her profile may need to update the profile 10 times in a given period of time to exceed the threshold value for “high” retention category but an employee that does not regularly change her profile may only need to update the profile 5 times in a given period of time to exceed the threshold value for “high” retention category. The threshold values for each category may be different for each group of employees, grouped by sharing a similar employment condition. Such employment condition may be location (city, region, state, country), job title, management level, department, etc.

The retention categories may be assigned dynamically based on the pattern of changes to the employee profile. In addition, the threshold value may change dynamically based on the pattern of changes to the employee profile. The pattern of changes may include increase or decrease in frequency or extent of changes to the profile. For example, if the employee updates her profile for a certain number of times in a period of time, her profile may be associated with “high” retention category. The system may determine that the certain number of updates to the employee profile is routine and may downgrade the retention category to “medium” and eventually to “low” even if the frequency of updates to her profile does not change during the downgrade.

The AI model may be updated based on user feedback to improve the assignment of retention categories. The user feedback may include whether an employee has left the employer, in which case the retention category associated with the employee profile may be updated to “outlier.” The user feedback may further include whether employee decided to remain with the employer after an engagement with management of the employer, in which case the retention category associated with the employee profile may be downgraded to “medium” or “low.”

In step 235, it may be determined whether an alert is triggered by the assigned retention category. Such trigger may be customized to the particular employer organization and may be based on employee, employee role, or other grouping or type. If an alert is determined not to be triggered, the method may return to step 210 for further monitoring of the online data sources 110A-N. If an alert is determined to be triggered, the method may proceed to step 240.

In step 240, an alert may be generated regarding one or more identified employees and associated data associated with the trigger. In some implementations, the alert may be presented within a custom graphic user interface (GUI) generated for display based on the assigned retention category. The custom GUI may be automatically generated and provided with a notification that the alert trigger (e.g., threshold for the assigned retention category) has been met or detected. The alert may be generated based on an employee profile being associated with a retention category (e.g., “outlier” category), an employee profile assigned a change score exceeding a threshold value for a retention category, or based on a profile setting of the user.

The profile setting of the user allows the notification to be customized based on how early the user wishes to intervene if the system detects a change in employee morale. For example, a user of the system may specify in the profile setting that a notification be generated by the system to alert the user if an employee profile of any employee of the user reaches “high” category. The profile setting of the user may further be used to customize the notification based on a specific employee or employee types. The user of the system may set the profile setting to track a certain employee or a group of employees sharing a common employment condition such that a notification is generated by the system if any employee among the group or a certain portion of the employees of the group is associated with a certain retention category. For example, the user may be alerted if employee profiles associated with a majority of IT employees working in San Francisco reached or exceeded a threshold value for “high” category. Upon receiving the notification, the user may choose to intervene and provide remedial action by engaging the employee with the profile associated with a certain retention category to retain the employee or engaging the manager of the employee to mandate retraining.

The feedback from the users after the intervention actions by the user may include information such as the retention category of the employee that was engaged, the kind of retraining offered to the manager, and whether the employee stayed or left the employment after the intervention. Based on whether the intervention action was successful, the feedback from the users can provide a recommendation on when to engage the employee to retain and when to offer manager retraining.

The graphic user interface displayed to the user of the system may also be customized based on the user profile or user input. The graphic user interface may be specified to display a visual representation of the number of employees with different retention categories at a specific time or over a period of time such that an employee morale at the specific time or the change in employee morale over time can be viewed. The graphic user interface may be specified to display a visual representation of the number of employees that share an employment condition (location, job title, management level, shared manager, etc.) over time to view the change in retention rate over time. For example, the number of employees under Manager A over time may be displayed in the graphic user interface to determine whether Manager A requires retraining.

As such, the graphic user interface may provide for customized ways (e.g., user-specific, group-specific, category-specific) of displaying data subsets filtered from vast quantities of online data and presented with specific recommendations selected and tailored for a particular target user (or user group or user category). In contrast to generic indices of aggregated data, therefore, the custom graphic user interface may provide for immediate access to a limited set of online data relevant to a particular target, as well as a limited set of additional display customizations based on selectable view parameters (e.g., different layers of granularity as to specific user, group, or category characteristics). The selectable parameters may thus allow for updates to be applied automatically to the custom graphic user interface including switching between different views and datasets of filtered data.

The amount of access to information in the graphic user interface or the notification can be limited based on the user. The information displayed to the user may depend on the position of the user, clearance level of the user, or place of employment of the user. The information provided to the user may be anonymized for privacy. For example, if the user wishes to see the change in number of IT employees globally across many employers, the private or identifying information of the employee would be omitted or inaccessible.

The graphic user interface may be used to extrapolate trends, predict employee morale, or provide a recommendation to the user regarding increasing or decreasing certain benefits to the employees. For example, the graphic user interface may display the change in the number of employees in working in region A over time that are affected by a change in employee benefits. The data may be used to predict the affect on the retention rate when the same benefits are changed in region B. The graphic user interface may be used to provide a recommendation which employee benefits to add or remove, based on providing data on how changing a certain employee benefit affected employee retention.

In step 245, it may be determined whether a systemic pattern is detected. A systemic pattern may be detected, for example, when a threshold number of employees are determined to have departed or identified as likely to depart an organization under similar circumstances. For example, employees in a particular role or tasked with particular sets of responsibilities in common may be identified as being associated with a systemic pattern. In another example, there may be a pattern whereby employees working under the same or common group of managers may be identified as having reached a threshold level within a specific time period.

In step 250, one or more recommendations may be generated to address the likely individual employee departure, as well as the systemic issue. Individual retention strategies may be tailored to the specific employee and may include one or more changes to the employment conditions of the individual employee. Systemic solutions may be geared more broadly and may change conditions for multiple employees, including employees that currently do not exhibit indicators of impending departure.

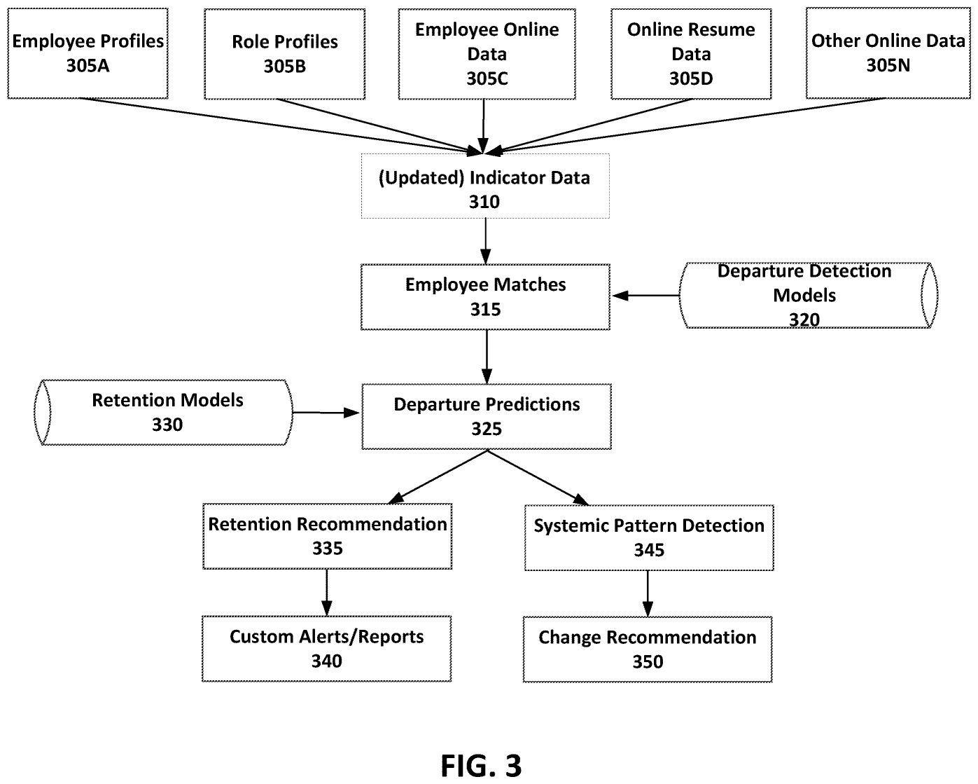

FIG. 3 illustrates exemplary data flows and content generated during implementation of intelligent retention assessment. As illustrated, multiple data streams—including employee profiles 305A, role profiles 305B, employee online data 305C, online resume data 305D, and other online data 305N—may be aggregated, filtered, and categorized to identify new and updated indicator data 310 relevant to predicting employment departure. The indicator data 310 may further be compared to specific individual employees or to employment roles (e.g., associated with multiple employees) and used to identify employee matches 315 (including matches based on employee groups).

The employee matches 315 may be analyzed by departure detection models 320 to identify new and emerging patterns associated with employee departure. The result of the analyses may include one or more departure predictions 325 for one or more employees being monitored. The departure predictions 325 may identify one or more specific employees as meeting a threshold level for escalating to the attention of one or more designated personnel within an organization tasked with monitoring and handling retention issues, such as human resources, people officers, culture officers, etc.

The departure predictions 325 may further be analyzed by retention models 330 to identify causes for the impending departure and to determine whether such cause is systemic. Individual retention recommendations 335 may be generated and sent in custom alerts/reports 340 to designated recipients tasked with re-engaging the employee. Where systemic patterns 345 are detected, additional change recommendations 350 may be generated and sent to the same or different recipients for implementing systemic changes at the organizational level.

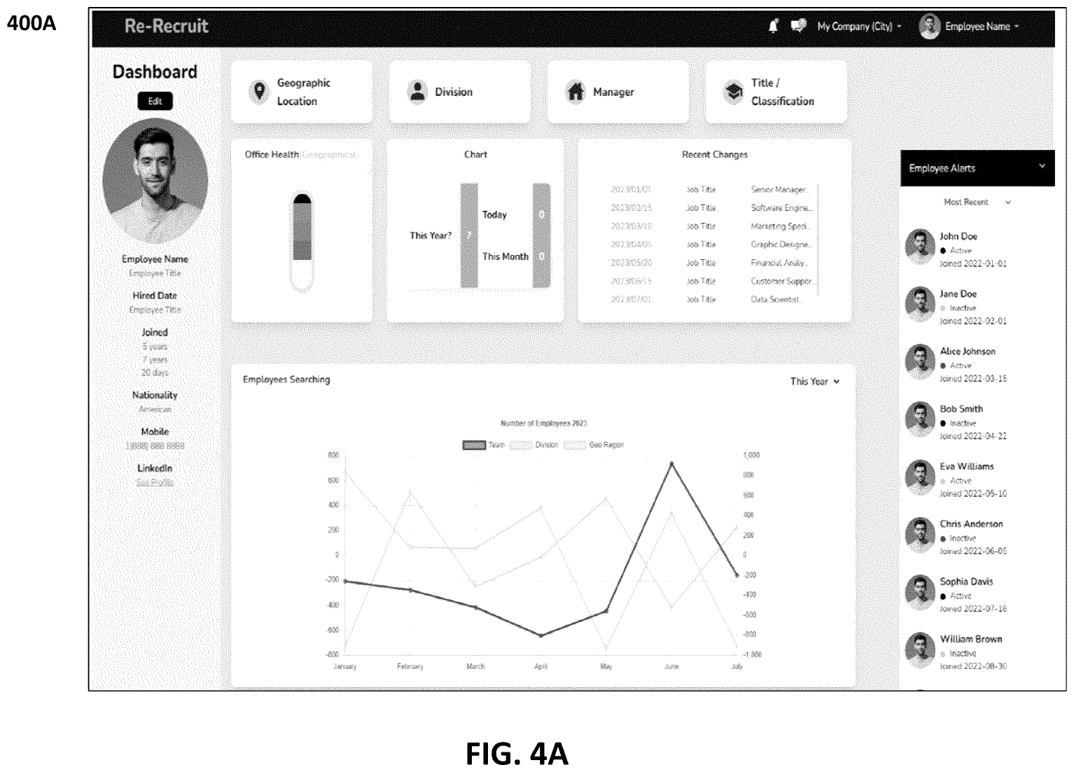

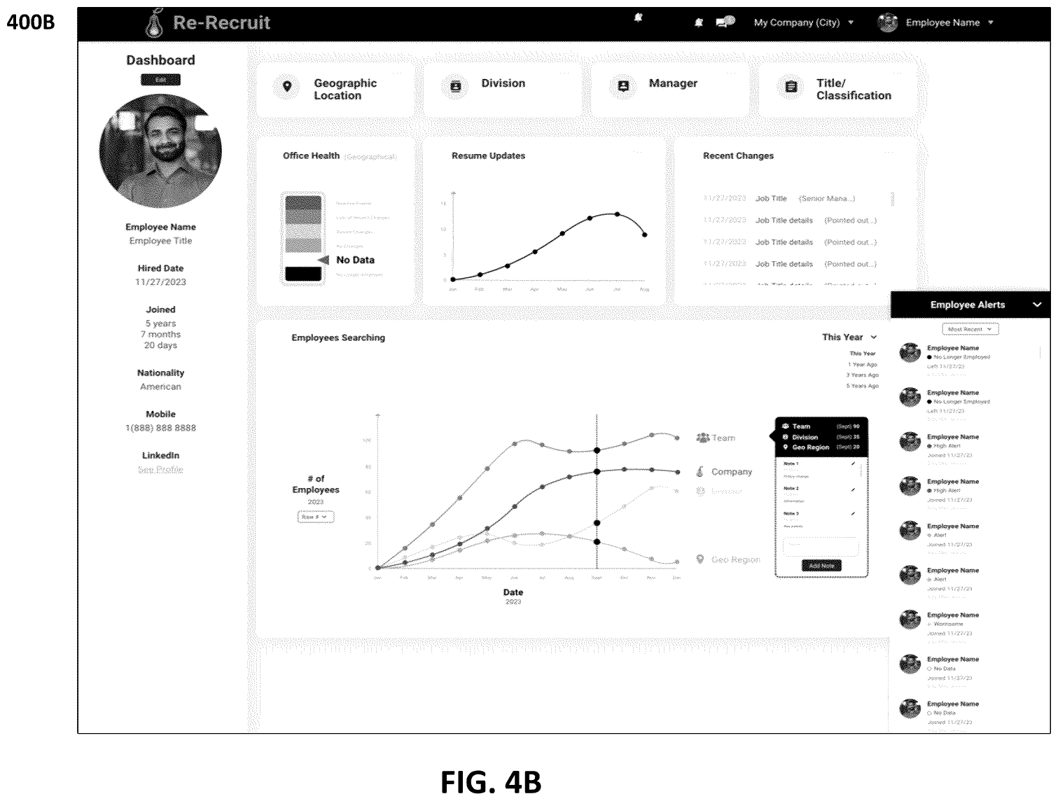

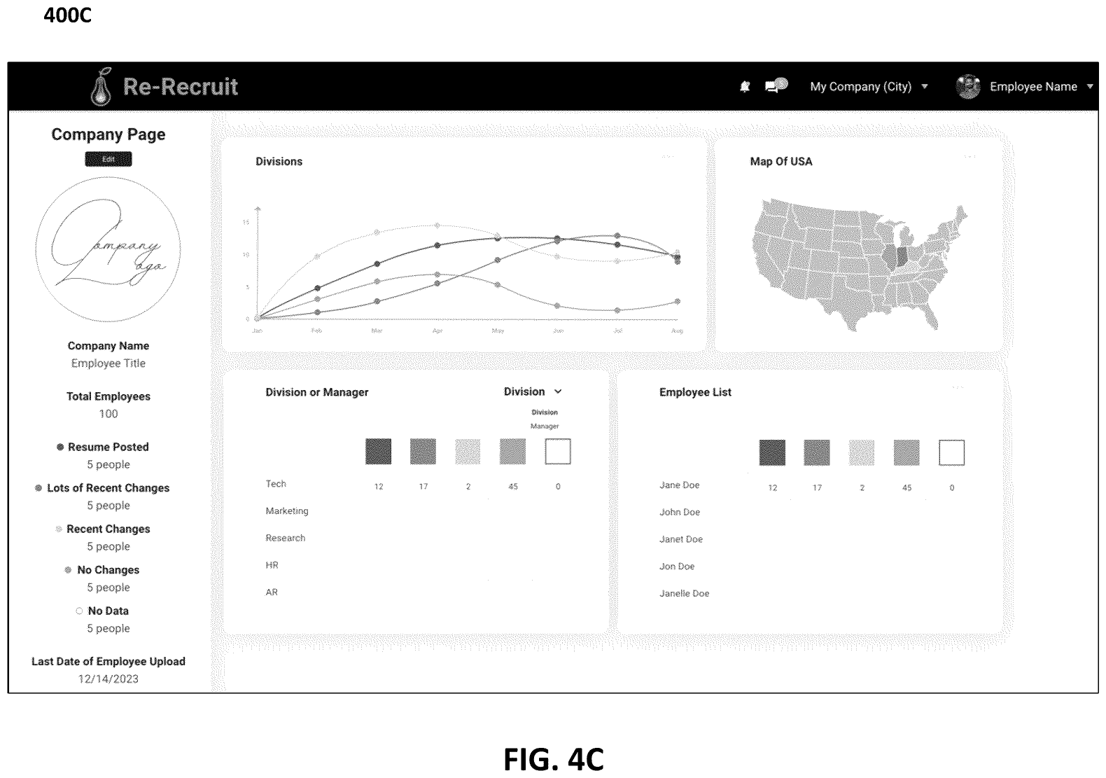

FIGS. 4A-C illustrates exemplary graphic user interface displays that may be generated during implementation of intelligent retention assessment. As illustrated, FIGS. 4A-C illustrate different levels of granularity with which employee retention data may be display. The graphic user interface of FIGS. 4A-B, for example, displays a dashboard regarding a specific employee, alongside visual representations of associated location, division, manager, title, office health, job title changes, and number of employees that share an employment condition. The lines representing the number of employees having different employment conditions, a specific team, division, geo location, may be overlaid. Alerts regarding one or more employees reaching or exceeding a threshold value for a retention category may be included in the graphic user interface. A list of recent changes to one or more employee profiles that the user has specified to monitor may be listed on the graphic user interface. A cumulate number of employees who left the employment in a specified period of time may be displayed on the graphic user interface.

Meanwhile, FIG. 4C illustrates an organizational view of data across multiple geographic locations, divisions, managers, and employees. Such graphic user interfaces and dashboards presented in FIGS. 4A-C may be customized based on express or implicit needs, preferences, etc., of the organization, as well as specific administrators tasked with handling retention issues, strategies, and plans.

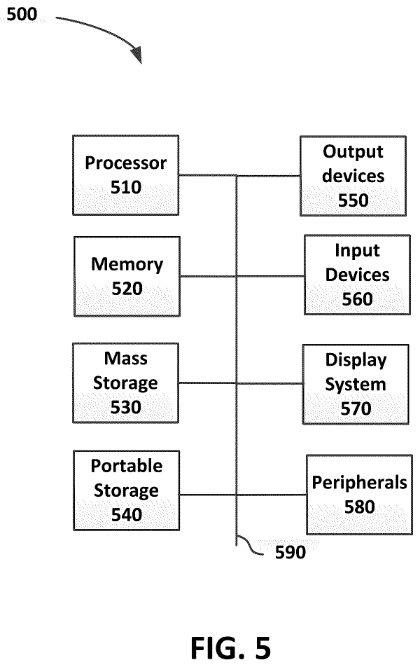

FIG. 5 illustrates an exemplary computing system 500 that may be used to implement an embodiment of the present invention. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for performing intelligent retention assessments, the method comprising:
storing information in memory regarding one or more retention categories each associated with a corresponding set of indicators;
monitoring a plurality of online platforms over the communication network, wherein the online platforms are monitored for one or more online data changes in accordance with a profile;
aggregating data from the online platforms regarding detected online data changes associated with the profile;
assigning one of the retention categories to the profile by applying an artificial intelligence model to the aggregated data, wherein the artificial intelligence model has been trained to correlate online data with the set of indicators corresponding to the retention categories; and
generating a custom graphic user interface based on a threshold associated with the assigned retention category, wherein the custom graphic user interface is configured to be displayed at a user device and includes a notification that the threshold associated with the assigned retention category has been met.

2. The method of claim 1, further comprising filtering the aggregated data in accordance with one or more filter parameters, wherein the retention category is assigned to a subset filtered from the aggregated data.

3. The method of claim 2, wherein the filter parameters include a target corresponding to one or more of an identified user, user group, or user category.

4. The method of claim 3, wherein the filtered subset includes data associated with one or more similarly-situated users, user groups, or user categories.

5. The method of claim 1, wherein generating the custom graphic user interface includes identifying a first subset of the aggregated data to include and a second subset of the aggregated data not to include as bases for generating the custom graphic user interface.

6. The method of claim 1, wherein the custom graphic user interface includes one or more selectable view parameters, and further comprising automatically updating the custom graphic user interface when one of the selectable view parameters is selected.

7. The method of claim 6, wherein the selectable view parameters corresponds to different filtered subsets of the aggregated data, and wherein automatically updating the custom graphic user interface is based on a filtered subset corresponding to the selected view parameter.

8. The method of claim 1, further comprising generating one or more retention predictions regarding the detected online data changes associated with the profile, wherein assigning the retention category is based on the predictions.

9. The method of claim 8, further comprising generating a custom recommendation associated with improved retention in relation to the retention category, wherein the custom recommendation is included in the custom graphic user interface.

10. A system for performing intelligent retention assessments, the system comprising:
memory that stores information regarding one or more retention categories each associated with a corresponding set of indicators;
a communication interface that communicates over the communication network to monitor a plurality of online platforms for one or more online data changes in accordance with a profile; and
a processor that executes instructions stored in memory, wherein the processor executes the instructions to:
aggregate data from the online platforms regarding detected online data changes associated with the profile;
assign one of the retention categories to the profile by applying an artificial intelligence model to the aggregated data, wherein the artificial intelligence model has been trained to correlate online data with the set of indicators corresponding to the retention categories, and
generate a custom graphic user interface based on a threshold associated with the assigned retention category, wherein the custom graphic user interface is configured to be displayed at a user device and includes a notification that the threshold associated with the assigned retention category has been met.

11. The system of claim 10, wherein the processor executes further instructions to filter the aggregated data in accordance with one or more filter parameters, wherein the retention category is assigned to a subset filtered from the aggregated data.

12. The system of claim 11, wherein the filter parameters include a target corresponding to one or more of an identified user, user group, or user category.

13. The system of claim 12, wherein the filtered subset includes data associated with one or more similarly-situated users, user groups, or user categories.

14. The system of claim 10, wherein the processor generates the custom graphic user interface by identifying a first subset of the aggregated data to include and a second subset of the aggregated data not to include as bases for generating the custom graphic user interface.

15. The system of claim 10, wherein the custom graphic user interface includes one or more selectable view parameters, and wherein the processor executes further instructions to automatically update the custom graphic user interface when one of the selectable view parameters is selected.

16. The system of claim 15, wherein the selectable view parameters corresponds to different filtered subsets of the aggregated data, and wherein the processor automatically updates the custom graphic user interface based on a filtered subset corresponding to the selected view parameter.

17. The system of claim 10, wherein the processor executes further instructions to generate one or more retention predictions regarding the detected online data changes associated with the profile, and wherein the processor assigns the retention category based on the predictions.

18. The system of claim 17, wherein the processor executes further instructions to generate a custom recommendation associated with improved retention in relation to the retention category, wherein the custom recommendation is included in the custom graphic user interface.

19. A non-transitory, computer-readable storage medium, having embodied thereon a program executable by a processor to perform a method for performing intelligent retention assessments, the method comprising:
storing information in memory regarding one or more retention categories each associated with a corresponding set of indicators;
monitoring a plurality of online platforms over the communication network, wherein the online platforms are monitored for one or more online data changes in accordance with a profile;
aggregating data from the online platforms regarding detected online data changes associated with the profile;
assigning one of the retention categories to the profile by applying an artificial intelligence model to the aggregated data, wherein the artificial intelligence model has been trained to correlate online data with the set of indicators corresponding to the retention categories; and
generating a custom graphic user interface based on a threshold associated with the assigned retention category, wherein the custom graphic user interface is configured to be displayed at a user device and includes a notification that the threshold associated with the assigned retention category has been met.
